(19) United States
(12) Patent Application Publication
(10) Pub. No.: US 2004/0255037 A1
(43) Pub. Date: Dec. 16, 2004

(54) System and method for authentication and security in a communication system

(76) Inventors: Lawrence J. Corvari, Normandy Park, WA (US); Kenneth A. Arneson, West Richland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/723,997

(22) Filed: Nov. 26, 2003

Related U.S. Application Data
(60) Provisional application No. 60/429,872, filed on Nov. 27, 2002.

(51) Int. Cl. H04L 9/00

(52) U.S. Cl. 709/229; 713/156; 709/201

(57) ABSTRACT

A system and method for authentication and security in a communication system is provided. The system provides for two-way or mutual authentication. In one embodiment, both the server and client must exchange valid certificates, otherwise communication will not be allowed to occur. This requirement is not limited to client/server, as server-to-server communication may also be required to exchange valid certificates. Furthermore, the user does not have to perform any special functions in order to exchange his/her certificate. The exchange of the certificates is transparent by way of the processes that are built into the system as a whole. The client provides the automatic interface to the certificate for purposes of exchange with services within the network. In one embodiment, the user initiates, through self-provisioning, a certificate signing request to the administrator system. The administrator system, either by manual or automatic means, approves the certificate signing request and forwards the request to the certificate authority. The certificate authority then signs the certificate signing request, thereby creating a valid certificate. The certificate is sent back to the administrator system which then, upon request by the client system, delivers the certificate to the client.

### CROSS-REFERENCE TO RELATED APPLICATION

This application claims the benefit of U.S. Provisional Application No. 60/429,872, filed Nov. 27, 2002, under the provisions of 35 U.S.C. § 119, the disclosure and drawings of which are incorporated herein by reference.

### FIELD OF THE INVENTION

This invention relates generally to communication systems, and more particularly to authentication and security in communication systems.

### BACKGROUND OF THE INVENTION

Numerous types of wireless networking standards currently exist. 802.11 and 802.16 are the IEEE standard for wireless LANs, which is designed to be compatible with Ethernet LANs, and is intended to allow properly equipped devices to communicate and exchange data with a base station located within a specified range. CDPD is the standard that allows for cellular packet data to be exchanged over the existing analog cellular network. GPRS (aka 2.5 G) is the “always on” packet data service for GSM, which is the cell phone standard for most countries in the world, and which can thus be used in one example to connect a laptop to a cell phone for surfing the Web or other purposes. Numerous other standards also exist such as 1×RTT (the CDMA equivalent of GPRS), WCDMA (aka 3 GPP, wideband CDMA), UMTS (next generation GSM, is the European member of the family of 3 G wireless standards and is based on GSM), etc. In summary, these standards allow users with various computer communication devices to exchange data over the communication networks once they come into range of the systems. As users roam between various network coverage areas, it would be desirable for them to be able to connect and communicate with the given network that they are in the range of, allow preference for higher bandwidth and more secure networks. Critical issues for such systems include authentication and security.

A common method for logging into networks involves the use of a user name and a password. While this provides a certain level of protection, it is desirable in many cases to have higher levels of authentication and security protection. With the structure and systems of many broadband wireless and wired communications networks already in place, it would be desirable to provide a system and method for more advanced authentication and security that could be added to one or more interconnected wireless networks without directly impacting the networks' abilities to provide data carriage services for the subscribers. In other words, it would be desirable to have an authentication and security system and method that could co-exist with the existing mobile data communications networks.

The present invention is directed to a system and method for authentication and security in a communications system. More specifically, the present invention is directed to a system and method of two factor authentication and security using established public key infrastructure techniques to exchange cipher keys that can be made to co-exist with existing mobile data communications networks.

### SUMMARY OF THE INVENTION

A system and method for authentication and security in a communication system is provided. The system provides for two-way or mutual authentication. In one embodiment, both the server and client must exchange valid certificates, otherwise communication will not be allowed to occur. This requirement is not limited to client/server, as server-to-server communication may also be required to exchange valid certificates. Furthermore, the user does not have to perform any special functions in order to exchange his/her certificate. The exchange of the certificates is transparent by way of the processes that are built into the system as a whole. The client provides the automatic interface to the certificate for purposes of exchange with services within the network.

In one embodiment, the user initiates, through self-provisioning, a certificate signing request to the administrator system. The administrator system, either by manual or automatic means, approves the certificate signing request and forwards the request to the certificate authority. The certificate authority then signs the certificate signing request, thereby creating a valid certificate. The certificate is sent back to the administrator system which then, upon request by the client system, delivers the certificate to the client.

It will be appreciated that the present invention provides a system and method for operating and securing wired and/or wireless broadband networks. In general, the system includes distributed software objects that enable bandwidth/revenue optimization and ensure that only authorized users can access the broadband resources. All services and users must present valid credentials before any communications can occur. Both asymmetrical and symmetrical encryption are utilized so as to ensure confidentiality. Two IP addresses are utilized, so as to allow for a connection regardless of any intervening networks. Furthermore, a mechanism is utilized for mobility, which is different than known mechanisms such as those utilized in IPv6 and IS-41. In addition, the authentication is provided centrally, and then peer-to-peer connections are established between the client and the sentry.

It will be appreciated that the network of the present invention can be implemented in either a simple home office/small office configuration, or as a complex network designed to offer wireless broadband to communities and enterprises. It is transport network independent, and can therefore adapt to a wide variety of wired and/or wireless network implementation scenarios.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a network formed in accordance with the present invention;

FIG. 2 is a flow diagram of a routine for generating a certificate that will be used by a client to gain access to the network;

FIGS. 3A and 3B are diagrams illustrating the flow of messages between network components when the certificate is generated and for a secure connection;

FIGS. 4A, 4B, and 4C are flow diagrams of a routine for registration and authentication;

FIG. 5 is a block diagram illustrating the flow of information between network components during registration and authentication;

FIG. 6 is a block diagram of selected network components;

FIGS. 7A and 7B are flow diagrams of a routine for a communication session between the network components of FIG. 6; and

FIGS. 8A-8C are block diagrams of a network illustrating the overall communications by which a user is assigned a physical and a virtual address and in which a tunnel mechanism is employed.

### DETAILED DESCRIPTION OF THE PREFERRED EMBODIMENT

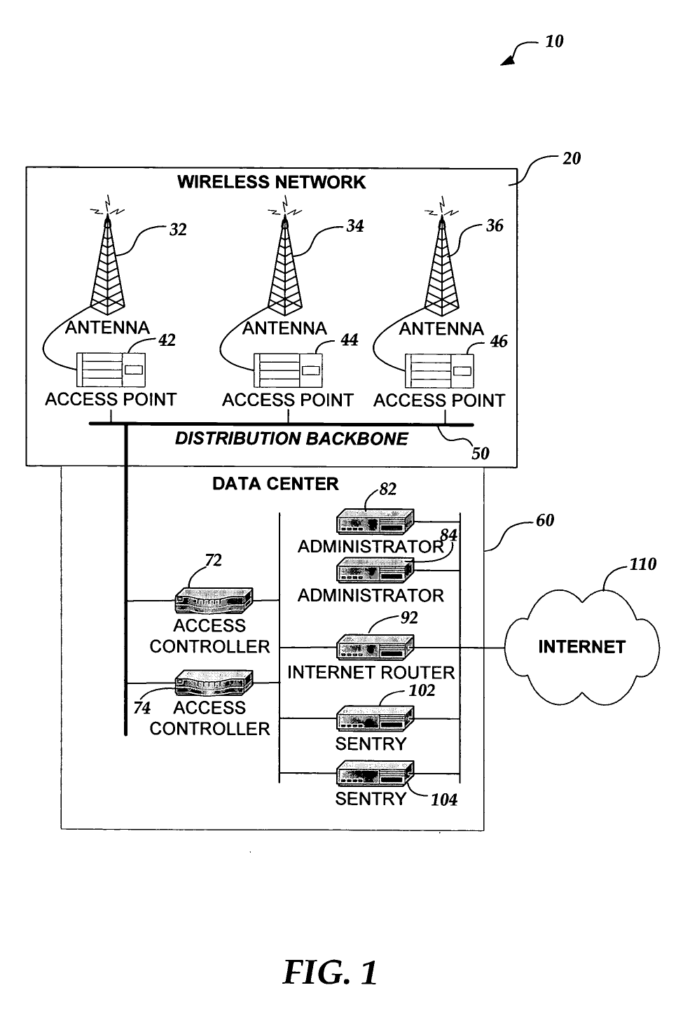

FIG. 1 is a block diagram of a network 10 that is formed in accordance with the present invention. The network 10 includes a wireless network 20 that is coupled by a distribution backbone 50 to a data center 60. The data center 60 is coupled to the Internet 110. The wireless network 20 includes antennas 32, 34 and 36, which are coupled to access point stations 42, 44 and 46, respectively. The access point stations 42, 44 and 46 are coupled through the distribution backbone 50 to the data center 60. In one embodiment, the wireless network 20 may be a Wi-Fi type network, although it will be understood that the present invention is equally applicable to other types of networks or combinations thereof (e.g., GPRS, 3 G, wired, etc.). As will be discussed in more detail below, mobile clients (not shown) access the network through wireless devices that transmit and receive signals to and from the antennas 32, 34 and 36.

The data center 60 includes access controllers 72 and 74, administrators 82 and 84, an Internet router 92, and sentry servers 102 and 104. The access controllers 72 and 74 are coupled to the distribution backbone 50. The role of the access controllers 72 and 74 is to firewall the wireless access from clients which do not hold valid certificates, as will be described in more detail below. The role of the administrators 82 and 84 is to administer and manage the network. This includes a provisioning system for users and network services, authentication services, session management services, and system management for sentry, and access controllers. It will be appreciated that multiple wired and/or wireless LANs can be operated from a single administrator. The role of the sentry servers 102 and 104 is to provide for end-to-end encryption and decryption of data, routing services and to server as the anchor to an external network, i.e., the Internet. It will be understood that the network 10 may be formed in any number of alternative configurations. For example, in one embodiment, the access controllers may alternatively be coupled to the administrators through the Internet.

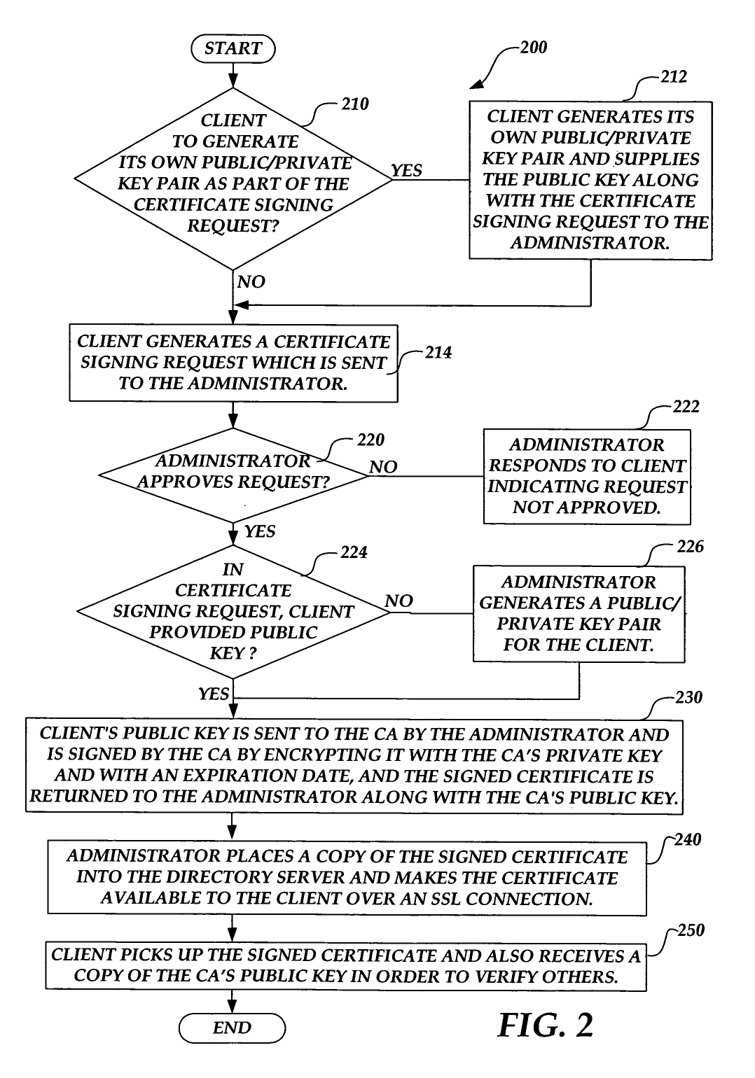

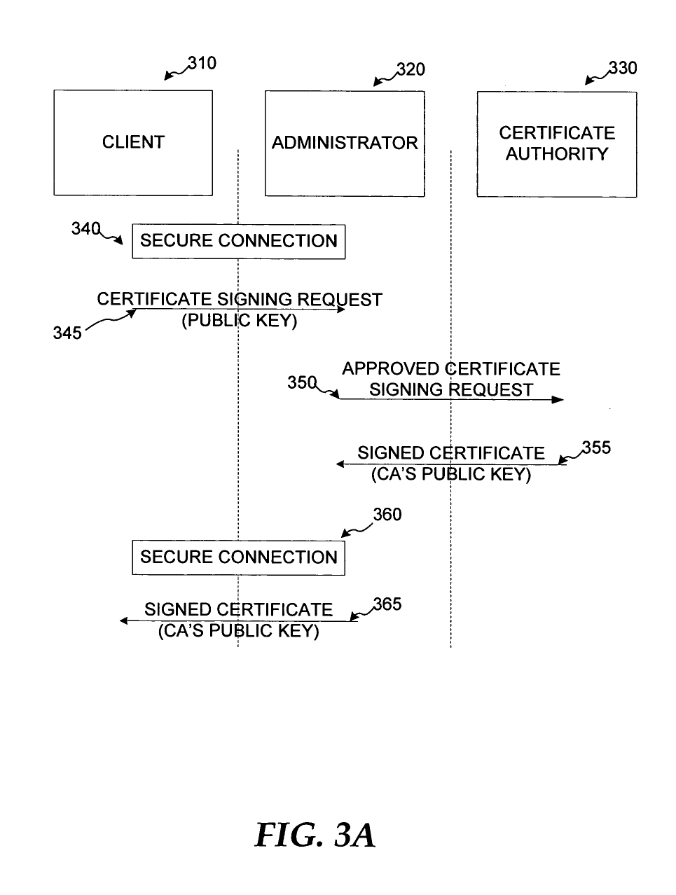

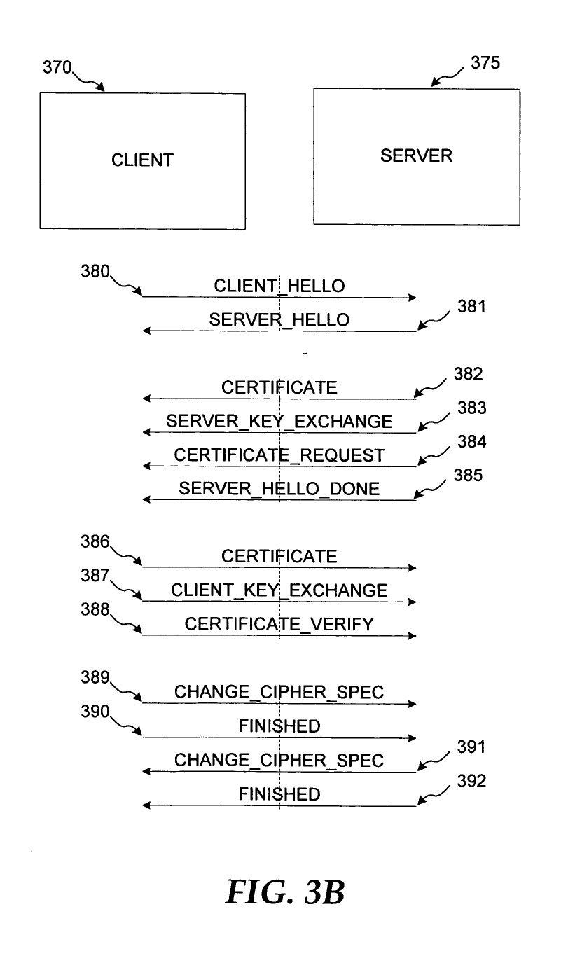

As will be described in more detail below with reference to FIGS. 2 and 3, in order for a user to gain access to the secure network 10, they must possess a valid certificate. In one embodiment, the certificate mechanism employed makes use of two-factor authentication. In this process, the user is required to hold something, in this case a valid certificate, and to know something, the unlock code for their certificate. This mechanism is commonly known as two-factor authentication. As part of the authentication mechanism, both the administrator and the client exchange certificates. Both certificates are examined to ensure that they are valid and have not been tampered with and to ensure that the certificates have been signed by a recognized certificate authority. This mechanism is a type of mutual or two-way authentication. Any users wishing to access the network, those who are providing administration of the network, as well as each component within the network (administrator, access controller, and sentry) are required to have certificates. Users are also required to possess valid logon IDs and passwords.

As will further be described in more detail below, in one embodiment the client communicates securely over a secure socket layer (SSL) connection with the administrator. In doing so, the client ensures that no one else can listen to the conversation. It will be appreciated that while a secure socket layer is discussed herein, that other standard secure communications mechanisms may also be used, such as others using RC4 type algorithms. The client creates a certificate request as part of the client provisioning process. The client (or the administrator as a proxy for the client) creates a public/private key pair using a public key algorithm. The client sends the certificate request to the administrator for approval over the secure socket layer connection. If the client has generated a public key, it is included with the request; otherwise the public key may be generated by the administrator after the request is received.

Any action of approval or disapproval takes place at the administrator. If the signing request is approved, the administrator sends the request on to the certificate authority for policy approval and to be signed. After signing by the certificate authority, the certificate (along with the public/private key pair if generated at the administrator) is sent back to the client through the administrator. This process is described in more detail below with reference to FIGS. 2 and 3.

It will be appreciated that the system provides a high level of security in that the certificate signing request includes both public key and personal information. Furthermore, in one embodiment the security system utilizes the AES and 3 DES encryption algorithm defaulted for a minimum of 128-bit encryption. The administrator includes software that provides the control and flexibility to change the encryption level to 192- or 256-bit encryption. In the case of wireless networks, as noted above, the access controller provides additional system security by providing firewall capabilities to ensure that only clients with valid certificates can communicate with the network and only to the administrator and sentry through predetermined ports.

As will be described in more detail below with reference to FIGS. 2 and 3, the security system automatically encrypts each data packet sent with a private encryption key. In one embodiment, the software of the system can be configured to change these keys as frequently as once every few minutes or upon the initiation of each communication session. This way, even if an unauthorized user were to intercept some data, it would be very difficult to decipher the encryption with such a small amount of data, and even more difficult to determine all the keys necessary to gather useful information.

FIG. 2 is a flow diagram of a routine 200 illustrating a certificate generation process. As shown in FIG. 2, at a decision block 210, a determination is made whether or not the client will generate its own public/private key pair as part of its certificate signing request. If the client is to generate its own public/private key pair, the routine proceeds to block 212, where the public/private key pair is generated. As will be described in more detail below, the public key that is produced by this process will be sent by the client as a part of the certificate signing request.

If the client will not generate its own public/private key pair, the routine continues to block 214. It should be noted that if the client does not generate its own public/private key pair, a public/private key pair may later be generated for it by the administrator, as will be described in more detail below with regard to block 226. At block 214, the client generates a certificate signing request which is sent to the administrator. If the client previously generated its own public/private key pair at block 212, the public key is supplied as a part of the certificate signing request at block 214. From block 214, the routine continues to a decision block 220.

At decision block 220, a determination is made as to whether or not the administrator approves the certificate signing request from the client. If the administrator does not approve the certificate signing request, then the routine continues to a block 222. At block 222, the administrator responds to the client indicating that the request was not approved. If at decision block 220 the administrator does approve the certificate signing request, then the routine continues to a decision block 224.

At decision block 224, a determination is made as to whether or not the client generated its own public/private key pair and included the public key as a part of the certificate signing request. If the client did not provide a public key, then the routine continues to a block 226. At block 226, the administrator generates a public/private key pair for the client. From block 226, the routine continues to a block 230. If at decision block 224 the client had already provided a public key, then the routine continues to block 230.

At block 230, the client's public key (that was either generated by the client at block 212 or by the administrator at block 226) is signed by the certificate authority. The certificate authority signs the public key by encrypting it with the certificate authority's private key and with an expiration date, and the certificate is returned to the administrator.

At a block 240, the administrator places a copy of the signed certificate into the directory server and makes the certificate available to the client over a secure socket layer connection. At a block 250, the client picks up the signed certificate.

FIG. 3A is a diagram illustrating the flow of messages between network components during the certificate generation process of FIG. 2. As illustrated in FIG. 3A, the network components between which messages pass include a client 310, an administrator 320, and a certificate authority 330. At the start of the process, a secure socket layer connection 340 is established between the client 310 and the administrator 320. At a communication line 345, the client 310 sends the certificate signing request to the administrator 320. As was described above with reference to FIG. 2, the client may also optionally generate a public/private key pair and include the public key as a part of the certificate signing request that is sent to the administrator 320. These communications at the communication line 345 generally correspond to blocks 210, 212 and 214 of FIG. 2.

At a communication line 350, if the certificate signing request is approved by the administrator 320, the administrator 320 forwards it to the certificate authority 330. A communication line 355 shows that after the certificate is signed by the certification authority by encrypting it with the certification authority's private key and with an expiration date and the signed certificate are sent by the certificate authority 330 to the administrator 320. These communications at the communication lines 350 and 355 generally correspond to the block 230 of FIG. 2.

As next illustrated in FIG. 3A, a secure connection 360 is established between the administrator 320 and the client 310. The administrator 320 places a copy of the signed certificate into the directory server and makes the certificate available to the client over the secure connection 360. At a communication line 365, the client 310 picks up the signed certificate from the administrator 320. These communications at the communication line 365 generally correspond to the blocks 240 and 250 of FIG. 2.

FIG. 3B is a diagram illustrating the flow of messages between the client and the server for a secure connection. FIG. 3B generally represents the secure socket layer exchange mechanism that may generally be referred to as a secure connection. As illustrated in FIG. 3B, the network components between which messages pass include a client 370 and a server 375.

At a communication line 380, a client hello message is sent from the client 370 to the server 375. At a communication line 381, the server 375 responds with a server hello message to the client 370. At communication lines 382-385, a series of communications are sent from the server 375 to the client 370. More specifically, at communication line 382 a certificate is sent, at communication line 383 a server key exchange is sent, at communication line 384 a certificate request is sent, and at communication line 385 a server hello done is sent.

At communication lines 386-390, a series of communications are sent from the client 370 to the server 375. More specifically, at communication line 386 a certificate is sent, at communication line 387 a client key exchange is sent, at communication line 388 a certificate verify is sent, at communication line 389 a change cipher spec is sent, and at communication line 390 a finished is sent. At communication lines 391 and 392, communications are sent from the server 375 to the client 370. More specifically, at communication line 391 a change cipher spec is sent, and at communication line 392 a finished is sent.

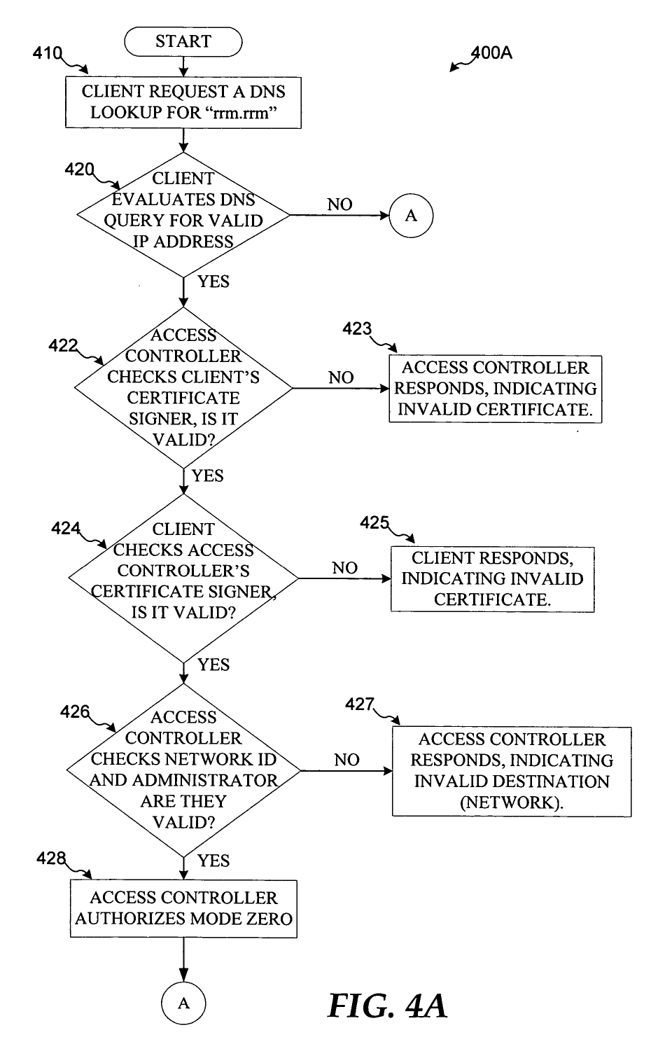

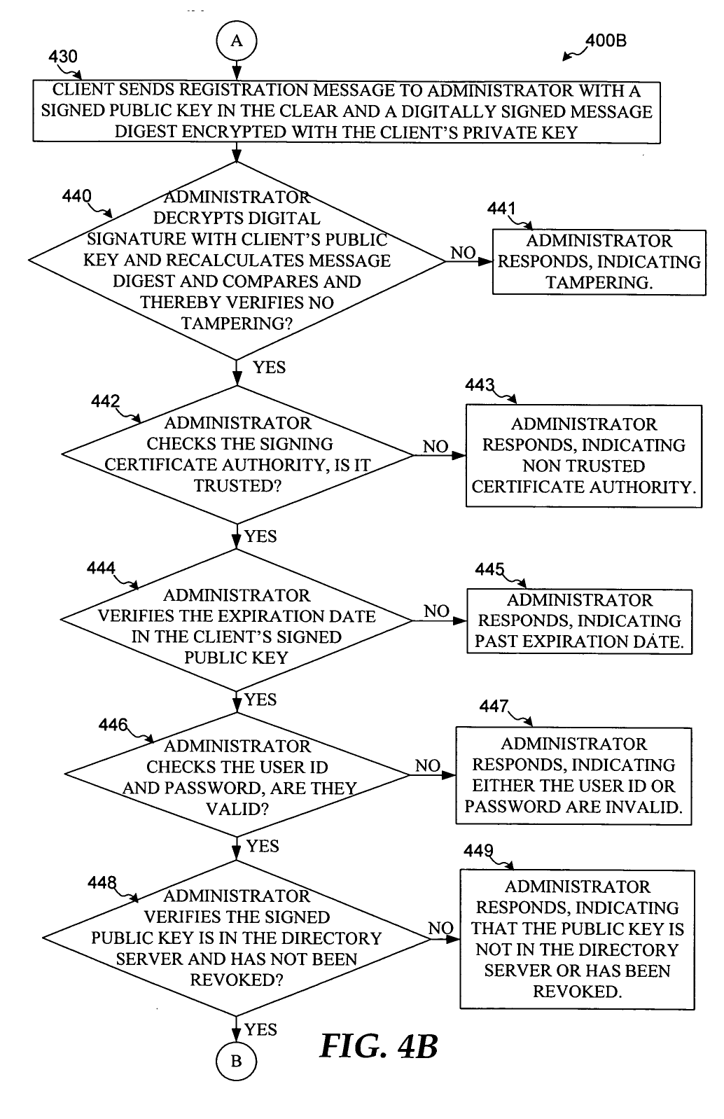

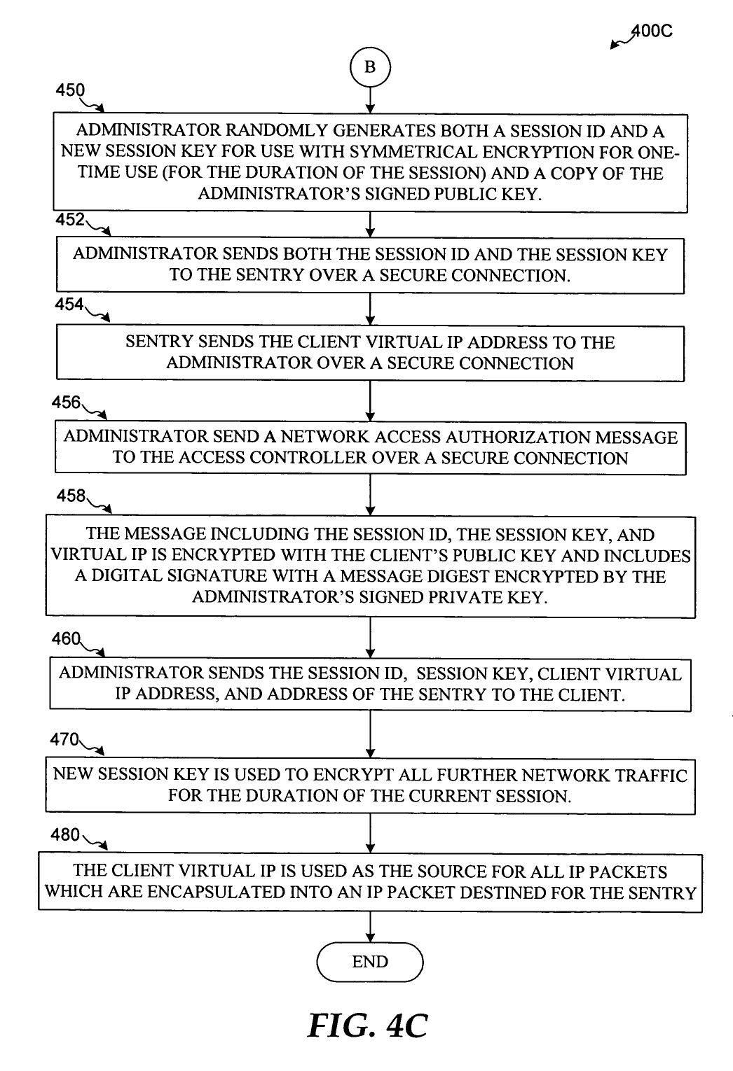

FIGS. 4A, 4B, and 4C are flow diagrams of a routine 400 for registration and authentication within a secure network. As shown in FIG. 4A, at a block 410 the client issues a domain name service request to resolve “rrm.rrm.” At decision block 420, the client evaluates the query response for a valid internet protocol address. If the client does not receive a valid address, the client continues to point A, which is continued in FIG. 4B. If the client determines that it has received a valid address, then the routine continues to decision block 422.

At decision block 422, the access controller validates the client's certificate that is provided by the client over a secure connection. If the access controller determines that the certificate is invalid because it is not signed by a recognized certificate authority, has been compromised or expired, then the process continues to block 423, where the access controller responds, indicating an invalid certificate. If the access controller successfully validates the client certificate, then the routine continues on to decision block 424.

At decision block 424, the client validates the access controller's certificate that is provided by the access controller over a secure connection. If the client determines that the certificate is invalid because it is not signed by a recognized certificate authority, has been compromised or expired, then the process continues to block 425, where the client responds, indicating an invalid certificate. If the client successfully validates the access controller certificate, then the routine continues on to decision block 426.

At decision block 426, the access controller validates that the network ID provided by the client is either the access controller's network ID or the network ID is allowed on the access controller's network. In addition, the address of the administrator is checked to see if it is a valid address on the access controller's network or it is an address that is allowed on the access controller's network. If the access controller determines that the network ID or administrator is invalid, then the routine continues to block 427, where the access controller responds, indicating an invalid destination (network). If the access controller validates the network ID and administrator, then the routine continues to block 428, where the access controller authorizes mode zero, and the routine then continues to point A.

As shown in FIG. 4B, from point A, the routine continues to block 430, where the client sends a registration message to the administrator. The registration message includes a signed public key that is not encrypted, along with a digitally signed message digest that is encrypted with the client's private key.

At a decision block 440, the administrator decrypts the digital signature with the client's public key and ensures that no tampering has occurred by recalculating the message digest and comparing. If the administrator is unable to verify that no tampering has occurred, then the routine continues to block 441, where the administrator responds, indicating that tampering has occurred. It will be understood that any time an error is detected within the system (e.g., an indication that tampering or attempts at unauthorized access or registration have occurred), the response may include notifications being sent to either the client and/or other network elements or the system administrator. The response may be either more or less detailed, from a simple notification of rejection, to a more detailed statement of the detected problem.

If at decision block 440 it is determined that the message digest is valid, then the routine continues to a decision block 442. At decision block 442, the administrator verifies that the signing certificate authority is in the administrator's list of trusted certificate authorities. If the signing certificate authority is not valid, then the routine continues to block 443, where the administrator responds, indicating a non-trusted certificate authority. If it is determined that the signing certificate authority is valid, then the routine continues to decision block 444.

At decision block 444, the administrator verifies the expiration date in the client's signed public key. If the expiration date is past, then the routine continues to block 445, where the administrator responds indicating that the expiration date is past. If it is determined that the expiration date has not passed, then the routine continues to a decision block 446.

At decision block 446, the administrator validates the user ID and password supplied by the client. If the user ID or password is not valid, then the routine continues to block 447, where the administrator responds, indicating that either the user ID or the password are invalid. If the user ID and password are valid, the routine continues to decision block 448.

At decision block 448, the administrator checks that the signed public key is in the directory server and has not been revoked. If the signed public key is not in the directory server or has been revoked, then the routine continues to block 449, where the administrator responds indicating that the public key is not in the directory server or has been revoked. If at decision block 448 it is determined that the signed public key is in the directory server and has not been revoked, then the routine continues to a point B, which is continued in FIG. 4C.

As shown in FIG. 4C, from point B, the routine continues to a block 450. At block 450 the administrator randomly generates a new session ID and a session key for use with symmetrical encryption for one-time use (for the duration of the session) and a copy of the administrator's signed public key.

At block 452, the administrator sends the session ID and session key to the sentry over a secure connection. At block 454, the sentry sends a virtual internet protocol (IP) address to the administrator to be used by the client. At block 456, the administrator sends a network access authorization message to the access controller. At block 458, the message including the session ID, session key, and virtual IP is encrypted with the client's public key so that only the client is able to decrypt the message. The message also includes a digital signature with a message digest encrypted by the administrator's signed private key.

At a block 460, the administrator sends the session ID, session key, virtual IP, and address of the sentry to the client. At block 470 the new session key is used for all further network traffic for the duration of the current session. At block 480, the client virtual IP address is used as the source address for all IP packets encapsulated into an IP packet with the destination address of the sentry.

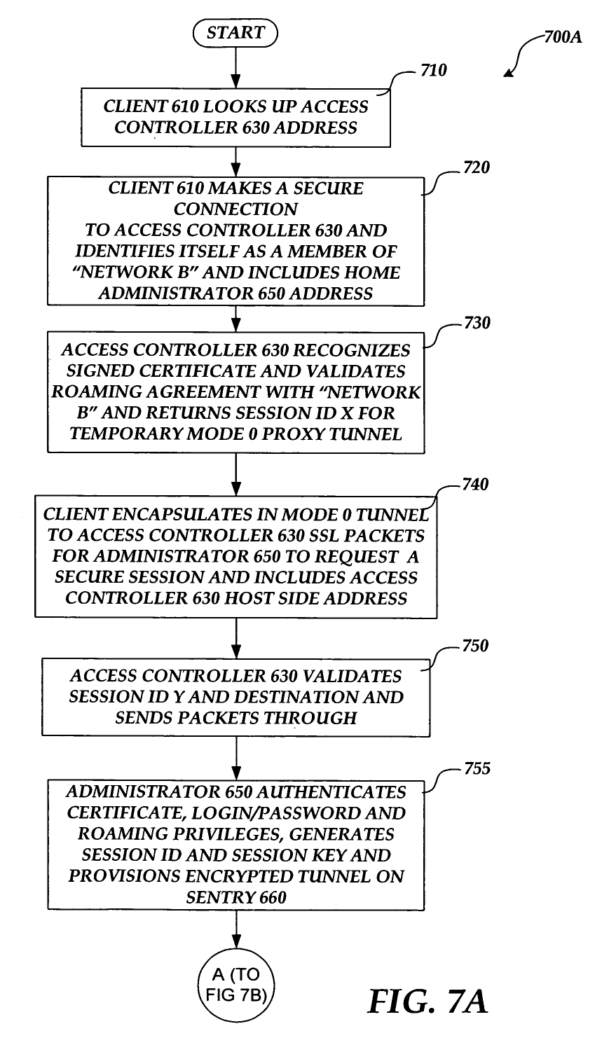

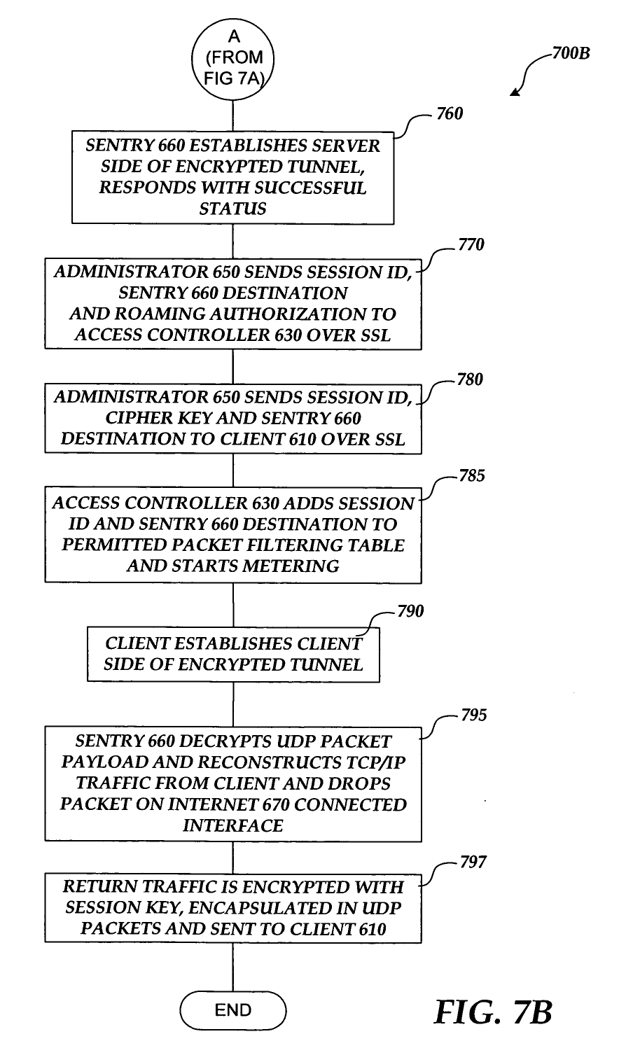

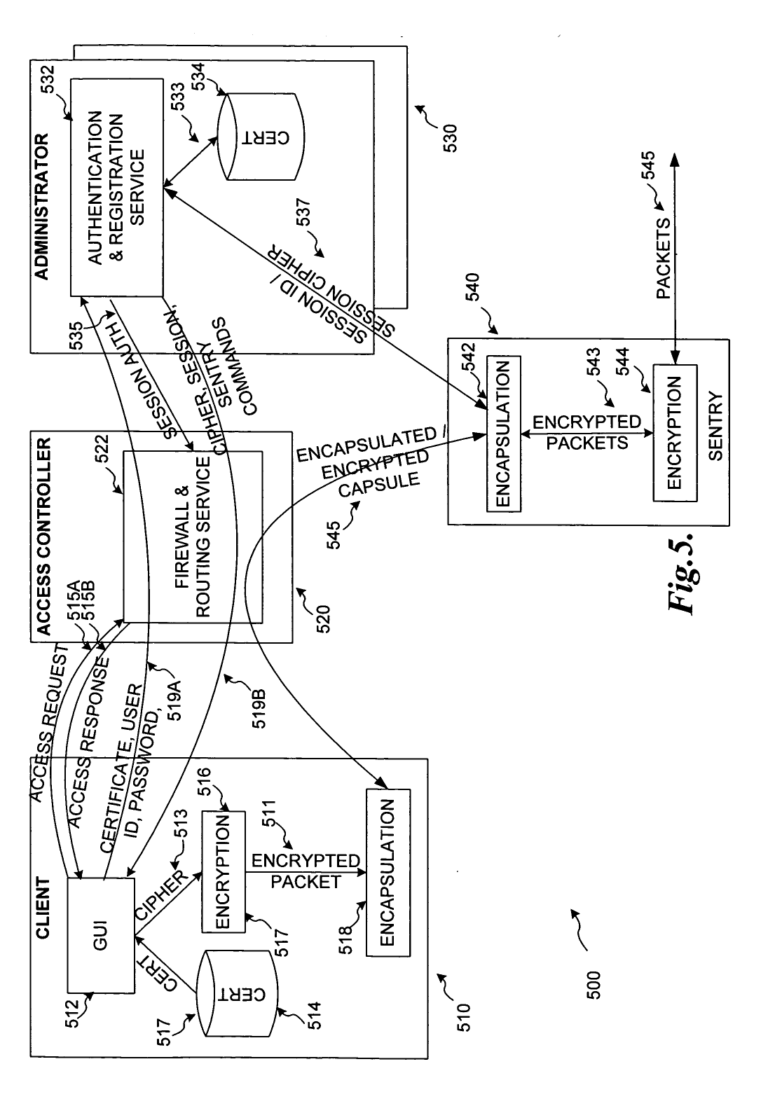

FIG. 5 is a block diagram of an embodiment of a network 500 where the routine of FIGS. 4A, 4B, and 4C is employed. As shown in FIG. 5, the network 500 includes a client 510, an access controller 520, administrator 530, and a sentry 540. The client 510 includes a graphical user interface 512 (e.g., Windows or Macintosh), a certificate component 514, an encryption component 516, and an encapsulation component 518. The graphical user interface 512 is connected to the encryption component 516 by a cipher communication line 513. The encryption component 516 and encapsulation component 518 may operate under the network driver interface specification. The certificate component 514 communicates with the graphical user interface 512 via a certificate communication path 517. The client 510 communicates with the access controller 520 via communication paths 515a and 515b.

The access controller 520 includes a firewall and routing service 522. The graphical user interface 512 of the client 510 communicates with the firewall and routing service 522 of the access controller 520 via the communication paths 515a and 515b. The communication path 515a flows from the graphical user interface 512 to the firewall and routing service 522, and includes information such as the certificate and network access authorization request information. The communication path 515b flows from the firewall and routing service 522 to the graphical user interface 512, and includes information such as network access authorization information.

The client 510 communicates with the administrator 530 via communication paths 519a and 519b. The administrator 530 includes an authentication and registration service 532 and a certificate component 534. The graphical user interface 512 of the client 510 communicates with the authentication and registration service 532 of the administrator 530 via the communication paths 519a and 519b. The communication path 519a flows from the graphical user interface 512 to the authentication and registration service 532, and includes information such as the certificate information, user ID, and password information. The communication path 519b flows from the authentication and registration service 532 to the graphical user interface 512, and includes information such as the session ID, session key, sentry, and commands. The authentication and registration service 532 communicates with the certificate component 534 via a communication path 533. The authentication and registration service 532 also communicates with the sentry service 540 via a communication path 545. The authentication and registration service 532 also communicates with the access controller 520 via communication path 535. The communication path 535 flows from the authentication and registration service 532 to the firewall and routing service 522, and includes information such as client session authorization information.

The security service 540 includes an encapsulate component 542 and an encryption component 544. The encapsulate component 542 communicates with the authentication and registration service 532 of the administrator 530 via the communication path 545, which carries the session ID and session key. The encapsulation service 542 communications to the encryption component 544 via the communication path 543, which caries the encrypted packets. The encryption component 544 also outputs and receives communication packets from other entities of the network via a communication path 545. The encapsulate component 542 communicates with the encapsulate component 518 of the client 510 through a communication path 545. The cipher connections 511, 525, and 545 indicate an encrypted flow of information. The secure connections 515a, 515b, 519a, and 519b indicates a transport level technology for authentication and data encryption.

As described above, the present invention provides a system and method for operating and securing wired and/or wireless broadband networks. In general, the system includes distributed software objects that enable bandwidth/revenue optimization and ensure that only authorized users can access the broadband resources. All services and users must present valid credentials before any communications can occur. It will be appreciated that the network of the present invention can be implemented in either a simple home office/small office configuration, or as a complex network designed to offer wireless broadband to communities and enterprises. It is transport network independent, and can therefore adapt to a wide variety of wired and/or wireless network implementation scenarios.

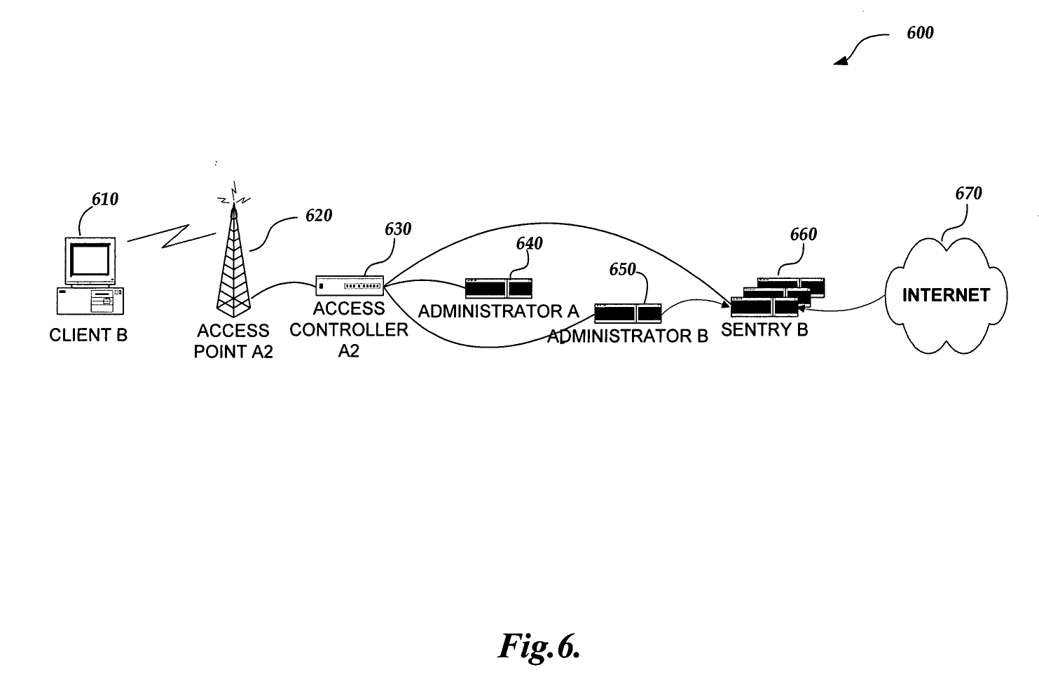

FIG. 6 is a block diagram of selected components of a network A and of a network B. Many of the components of FIG. 6 are similar to the components described above with reference to FIG. 1. Due to the similarities in configuration and operation, only certain aspects of the components of FIG. 6 that require additional explanation are described below

As shown in FIG. 6, in the overall network 600, a customer 610 is linked to an access point 620, which in turn is linked to an access controller 630. The access controller 630 is also linked to an administrator 640, an administrator 650, and a sentry 660. The sentry 660 is also linked to the administrator 650, as well as to the Internet 670. As further illustrated in FIG. 6, the administrator 640 has an “A” designation, while the access point 620 and the access controller 630 have “A2” designations. The client 610, administrator 650 and sentry 660 have “B” designations. In general, the “A” and “B” designations are indicative of a “network A” and a “network B.” For example, as will be described in more detail below with reference to FIGS. 7A and 7B, customer 610, administrator 650 and sentry 660 are considered to be part of the “network B”, for which a roaming agreement is validated.

FIGS. 7A and 7B are flow diagrams of a routine 700 which illustrates a communication session between the components of the networks A and B of FIG. 6. As shown in FIG. 7A, at a block 710 the client 610 from network B looks up the access controller 630 address from network A. At a block 720, the client 610 makes an SSL connection to the router 630 and identifies itself as a member of “network B” and includes its home administrator 650 address. At a block 730, the access controller 630 recognizes the signed certificate and validates the roaming agreement with “network B” and returns a session ID X for a temporary mode 0 proxy tunnel.

At a block 740, the client 610 encapsulates in the mode 0 tunnel to access controller 630 the SSL packets for the administrator 650 to request a secure session and includes the access controller 630 host side address. At a block 750, the access controller 630 firewall and routing service validates the session ID and destination and sends the packets through. At a block 755, the administrator 650 authenticates the certificate, the login/password and roaming privileges, and generates a session ID Y and a session key and provisions an encrypted tunnel on the sentry 660. From block 755, the routine continues to a point A, which is continued in FIG. 7B.

As shown in FIG. 7B, from point A the routine continues to a block 760 where the sentry 660 establishes the server side of the encrypted tunnel, and responds with a successful status. In one embodiment, the encrypted tunnel may be 256 bits. At a block 770, the administrator 650 sends the session ID Y, the sentry 660 destination and roaming authorization to the access controller 630 over an SSL connection. At a block 780, the administrator 650 sends the session ID, session key and sentry 660 destination to the client 610 over an SSL connection. At a block 785, the access controller 630 adds session ID Y and sentry 660 destination to the permitted packet routing table and starts the metering of the session. At a block 790, the client establishes the client side of the encrypted tunnel. At a block 795, the sentry 660 decrypts the UDP packet payload and reconstructs the TCP/IP traffic from the client 610 and drops the packet on the Internet 670 connected interface. At a block 797, the return traffic is encrypted, is encapsulated in UDP packets, and is sent to the client 610.

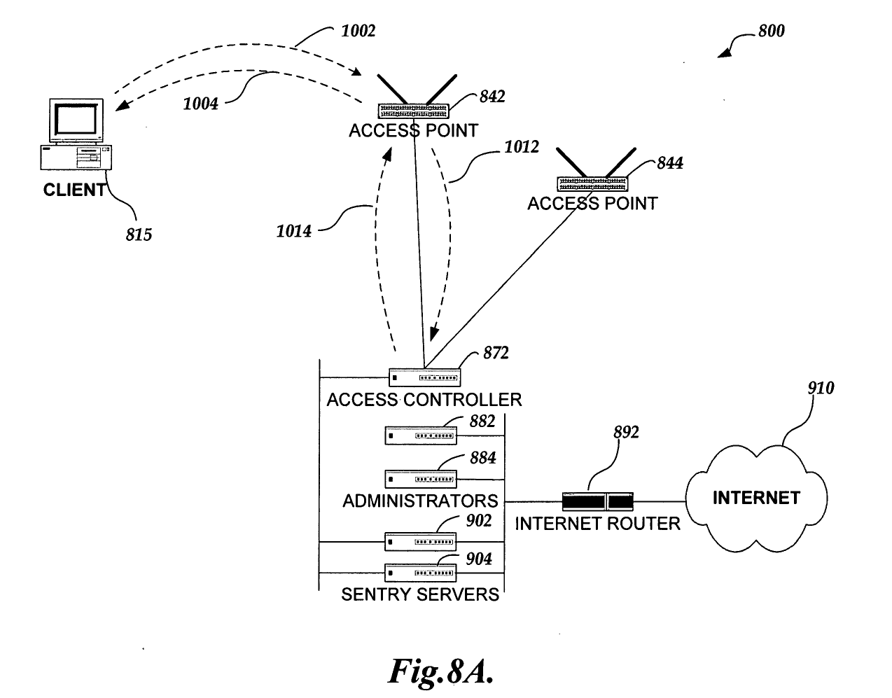

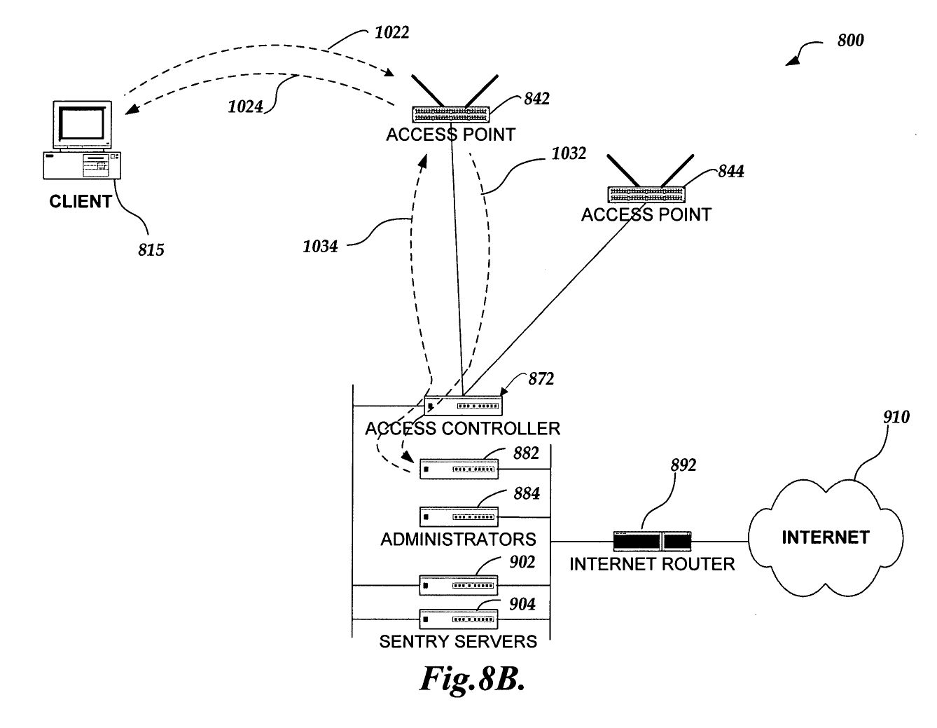

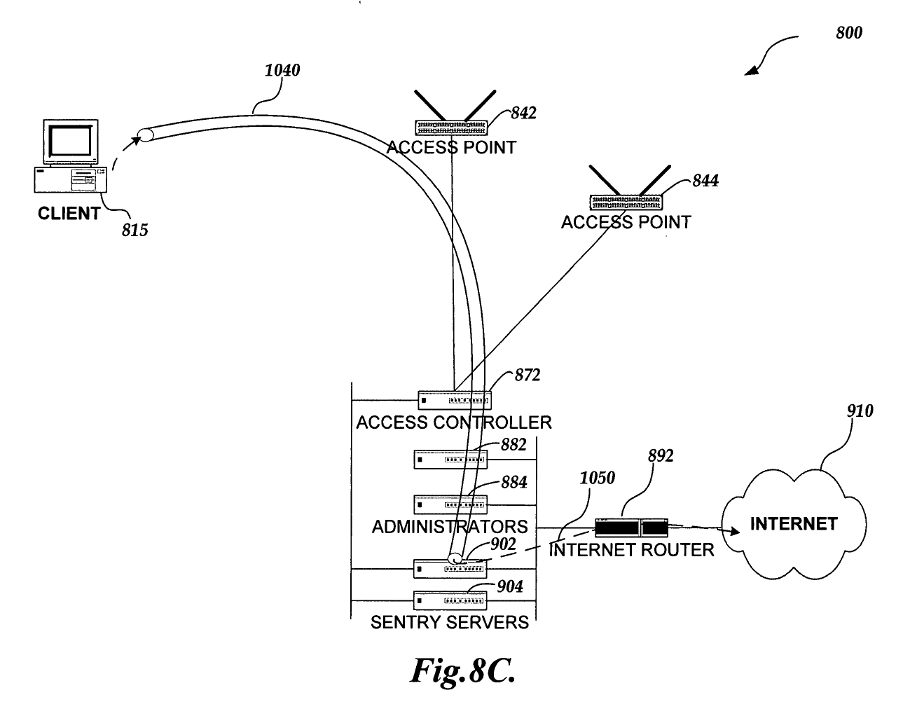

FIGS. 8A-8C are block diagrams of a network 800 illustrating the overall communications by which a user is assigned a physical and a virtual address and in which a tunnel mechanism is employed. Many of the components of the network 800 are similar to the components described above with reference to FIG. 1. Due to the similarities in configuration and operation, only certain aspects of the components of the network 800 that require additional explanation are described below.

As shown in FIG. 8A, the network 800 includes a client 815 which is coupled to an access point 842. The access point 842 and an access point 844 are coupled to an access controller 872. The access controller 872 is generally part of a data center which includes a number of administrators 882 and 884, a number of sentry servers 902 and 904, and an Internet router 892. The Internet router 892 is coupled to the Internet 910.

It will be appreciated that, as described above, in a system such as the network 800 the present invention initially provides an improvement over known communication systems in that an automatic interface to a certificate authority is provided. As described above, the automatic interface to the certificate authority is part of the user-based provisioning. In a system such as the network 800, the user initiates, through self-provisioning, a certificate signing request to the administrator system (e.g., administrator 882). The administrator system, either by manual or automatic means, approves the certificate signing request and forwards the request to the certificate authority. The certificate authority then signs the certificate signing request, thereby creating a valid certificate. The certificate is sent back to the administrator system which then, upon request by the client system, delivers the certificate to the client.

In accordance with the present invention, two IP addresses are assigned to a client, including a physical address and a virtual address. FIG. 8A illustrates selected communications in the network 800 for the assigning of a physical address to a client. As shown in FIG. 8A, communication lines 1002 and 1004 illustrate communications between the client 815 and the access point 842, while communication lines 1012 and 1014 illustrate communications between the access point 842 and the access controller 872. The physical address is assigned to the client 815 using dynamic host configuration protocol (DHCP) with the access controller 872 acting as the DHCP server. The physical address is the IP address that is used for the encryption and encapsulation service which occurs between the client 815 and the sentry.

FIG. 8B shows communications illustrating the assigning of the virtual IP address for the user 815. As shown in FIG. 8B, communication lines 1022 and 1024 illustrate communications between the user 815 and the access point 842, while communication lines 1032 and 1034 show communications between the access point 842 and the administrator 882. In accordance with the flow of communications in FIG. 8B, once the client 815 is authenticated and registered, the sentry assigns a virtual IP address which in one embodiment can be a public IP address. This is the address that the outside world knows.

In one embodiment, the virtual address is actually obtained from the sentry that the administrator 882 is assigning to the client 815. The address can be public or private (and therefore network address translated (NATed)). It will be appreciated that the use of the virtual IP address is important for providing mobility. The physical IP address can change because of mobility, but the virtual IP address will remain the same, and as a result, datagrams destined for the client 815 will be routed appropriately to the current location of the client 815.

FIG. 8C shows communications illustrating the tunnel mechanism of the network. As shown in FIG. 8C, a communication tunnel 1040 is provided between the client 815 and the sentry 902. A communication line 1050 is also shown between the sentry 902 and the Internet 910, but could be to any internetwork. In one embodiment, the mechanism employed for tunneling is transport independent. In general, any higher level protocol will be supported through the tunnel mechanism. Data is encapsulated and de-encapsulated transparently at both the client 815 and the sentry 902.

It will further be appreciated, that as described above, the present invention provides for two-way or mutual authentication. In one embodiment, both the server and client must exchange valid certificates; otherwise communication will not be allowed to occur. This requirement is not limited to client/server, as server-to-server communication may also be required to exchange valid certificates. Furthermore, the user does not have to perform any special functions in order to exchange his/her certificate. The exchange of the certificates is transparent by way of the processes that are built into the system as a whole. The client provides the automatic interface to the certificate for purposes of exchange with services within the network.

While the preferred embodiment of the invention has been illustrated and described, it will be appreciated that various changes can be made therein without departing from the spirit and scope of the invention.

1. A method for providing certificates in a communication system, the communication system comprising a client and a certificate authority, the method comprising:
the client utilizing self-provisioning to initiate a certificate signing request;
the certificate authority receiving the certificate signing request and creating a valid certificate by signing the request; and
the valid certificate being returned to the client.

2. The method of claim 1, wherein the communication system further comprises an administrator, the administrator receiving the certificate signing request from the client and approving the request before forwarding it to the certificate authority.

3. The method of claim 2, wherein after the request is signed by the certificate authority to create a valid certificate, the valid certificate is sent back to the administrator before it is delivered to the client.

4. The method of claim 3, wherein the delivery of the valid certificate to the client comprises placing the certificate into a directory server which is then made available to the client.

5. The method of claim 1, wherein when the certificate signing request is received by the certificate authority, a public/private key pair is received along with the certificate signing request.

6. The method of claim 5, wherein the public/private key pair is generated by the client.

7. The method of claim 5, wherein the public/private key pair is generated by an administrator.

8. The method of claim 1, wherein as part of the signing of the request by the certificate authority, the certificate is encrypted with the certificate authority's private key.

9. The method of claim 8, wherein the signing of the request by the certificate authority further comprises including an expiration date.

10. The method of claim 8, wherein the signing of the request by the certificate authority further comprises including the certificate authority's public key.

11. The method of claim 10, wherein when the client receives the signed certificate, the client also receives a copy of the certificate authority's public key.

12. The method of claim 1, wherein after the client receives the valid certificate, the valid certificate may be utilized by the client to initiate a communication session which utilizes both asymmetrical and symmetrical encryption.

13. The method of claim 1, wherein the client is assigned two IP addresses, including a physical address and a virtual address.

14. The method of claim 13, wherein when the client is mobile, the physical address may change but the virtual address remains the same, thus allowing communications destined for the client to be routed appropriately to the client's current location.

15. The method of claim 1, wherein the communication system provides authentication centrally, and then allows peer-to-peer connections to be established between the client and a sentry.

16. The method of claim 1, wherein both the client and a server are required to exchange valid certificates in order to establish a communication session.

17. A communication system coupled to a network, the network providing access points for clients, the communication system comprising:
an administrator for administrating and managing the network;
an internet router;
a sentry for providing end-to-end encryption and decryption of data to and from the Internet; and
an access controller for firewalling access to the communication system, wherein the clients are required to hold valid certificates in order to access the communication system.

18. The system of claim 17, wherein a client utilizes self-provisioning to initiate a certificate signing request, the sentry receiving the signing request and creating a valid certificate by signing the request, the valid certificate being returned to the client.

19. The system of claim 18, wherein the administrator receives the certificate signing request from the client and approves the request before forwarding it to the sentry.

20. The system of claim 17, wherein the sentry utilizes both asymmetrical and symmetrical encryption to ensure confidentiality.

21. The system of claim 17, wherein clients are assigned two IP addresses, including a physical address and a virtual address.

22. The system of claim 21, wherein when the client is mobile the physical address may change but the virtual address remains the same, thus allowing communications destined for the client to be routed appropriately to the client's current location.

23. The system of claim 17, wherein within the communication system authentication is provided centrally, after which peer-to-peer connections may be established between a client and the sentry.

24. The system of claim 17, wherein both the client and a server are required to exchange valid certificates in order to establish a communication session.

25. The system of claim 17, wherein the access points in the network may be wired or wireless.

26. A method for assigning addresses to clients in a communication system, the method comprising:
assigning a physical IP address to a client; and
assigning a virtual IP address to the client.

27. The method of claim 26, wherein when the client is mobile the physical address may change but the virtual address remains the same, thus allowing communications destined for the client to be routed appropriately to the client's current location.

28. The method of claim 26, wherein the physical IP address is assigned to the client using a dynamic host configuration protocol (DHCP).

29. The method of claim 28, wherein the communication system further comprises an access controller which acts as the DHCP server.

30. The method of claim 26, wherein the virtual address is a public IP address.

31. The method of claim 26, wherein the communication system further comprises a sentry that is assigned to the client, wherein the virtual address is obtained from the sentry.

32. The method of claim 26, wherein the virtual address is network address translated (NATed).

33. The method of claim 26, wherein the communication system utilizes both asymmetrical and symmetrical encryption to ensure confidentiality.

34. The method of claim 26, wherein in the communication system authentication is provided centrally, after which peer-to-peer connections may be established between the client and a sentry.
